(19) United States
(12) Patent Application Publication
(10) Pub. No.: US 2025/0391080 A1
(43) Pub. Date: Dec. 25, 2025

(54) Virtual-Environment-Reactive Persona

(71) Applicant: Apple Inc., Cupertino, CA (US)

(72) Inventors: Long H. Ngo, San Jose, CA (US); Frank Olivier, San Francisco, CA (US); Ana G. Williams, Cupertino, CA (US)

(21) Appl. No.: 19/205,402

(22) Filed: May 12, 2025

Related U.S. Application Data
(60) Provisional application No. 63/663,833, filed on Jun. 25, 2024.

(51) Int. Cl. G06T 13/40; G06F 3/01

(52) U.S. Cl. CPC G06T 13/40; G06F 3/011

(57) ABSTRACT

Generating an avatar representation of a user involves obtaining scene data, determining environmental features, and obtaining tracking data for the user. An environmentally-adjusted geometric representation of the user is generated and presented in the scene. The environmentally-adjusted geometric representation is generated based on the tracking data and the environmental features, and is used to reflect environmental features of the scene in the virtual representation of the user. The environmentally-adjusted geometry representation enables a view of the avatar that appears to reflect physical characteristics of the scene in which the avatar is presented.

### BACKGROUND

Computerized characters that represent users are commonly referred to as avatars. Avatars may take a wide variety of forms including virtual humans, animals, and plant life. Existing systems for avatar generation tend to inaccurately represent the user, require high-performance general and graphics processors, and generally do not work well on power-constrained mobile devices, such as smartphones or computing tablets. Further, avatars can look cartoonish and not reflective of reality. Thus, what is needed is an improved technique to generate and render realistic avatars.

### BRIEF DESCRIPTION OF THE DRAWINGS

FIG. 1 shows a flow diagram for generating an avatar of a subject that is reactive to a scene, according to some embodiments.

FIG. 2 shows a flowchart of a technique for determining an environmentally-adjusted persona geometry, according to one or more embodiments.

FIG. 3 shows a flow diagram of a technique for generating an environmental reactive persona, according to one or more embodiments.

FIG. 4 shows a flowchart of a technique for modifying a geometry representation of a user based on motion features, in accordance with one or more embodiments.

FIG. 5 shows a flowchart of a technique for modifying an environment-agnostic avatar based on motion features in a scene, according to some embodiments.

FIG. 6 shows, in block diagram form, a simplified system diagram according to one or more embodiments.

FIG. 7 shows, in block diagram form, a computer system in accordance with one or more embodiments.

### DETAILED DESCRIPTION

This disclosure relates generally to techniques for enhanced real-time rendering of a photo-realistic representation of a user. More particularly, but not by way of limitation, this disclosure relates to techniques and systems for rendering a representation of a user in a manner such that the representation appears to react to physical characteristics of the scene in which the representation of the user is presented.

According to some embodiments described herein, avatar data is enhanced by embedding physical properties of the environment, such as wind, rain, gravity, and lighting, into the generating or rendering process. In some embodiments, the dynamic movement of the persona may be configured to reflect real-life movement of the user and the environmental factors. In some embodiments, techniques described herein are directed to adjusting or augmenting features of a user based on environmental features for a scene in order to generate persona data that comports to the characteristics of the physical environment. As an example, tracking data, enrollment data, or the like for a user may be adjusted or augmented based on motion or displacement features from environmental features for the scene, such that when the persona is rendered, the rendered persona reflects the environmental characteristics of the scene from which the environmental features were obtained. As another example, persona data may be received at a device which is configured to render the persona in a particular scene may obtain environmental features for the scene, determine portions of the persona affected by the environmental features, and modifying the persona data during rendering to reflect the environmental features.

In some embodiments, a virtual representation of a user may be presented in a different scene, either physical scene or virtual scene, from the scene in which tracking data is captured. As such, embodiments described herein provide a technical improvement for using environmental features to enhance a persona in order to provide a virtual representation of a user that appears and moves realistically based on an environment in which the virtual representation is presented.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood to refer necessarily to the same embodiment or to different embodiments.

It should be appreciated that in the development of any actual implementation (as in any development project), numerous decisions must be made to achieve the developer's specific goals (e.g., compliance with system and business-related constraints) and that these goals will vary from one implementation to another. It should also be appreciated that such development efforts might be complex and time-consuming but would nevertheless be a routine undertaking for those of ordinary skill in the art of image capture having the benefit of this disclosure.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

For purposes of this application, the term “persona” refers to a virtual representation of a subject that is generated to accurately reflect the subject's physical characteristics, movements, and the like. A persona may be a photorealistic avatar representation of a user.

For purposes of this application, the term “copresence environment” refers to a shared XR environment among multiple devices. The components within the environment typically maintain consistent spatial relationship to maintain spatial truth.

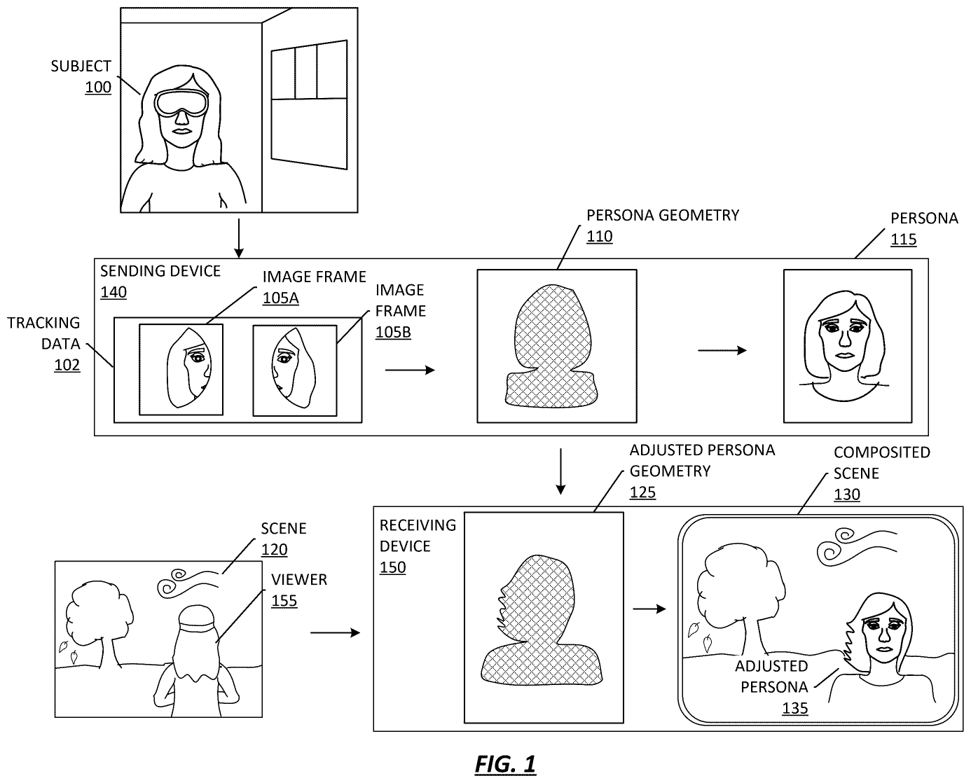

FIG. 1 shows a flow diagram for generating a persona of a subject that is reactive to a scene, according to some embodiments. In particular, FIG. 1 depicts one or more embodiments in which an avatar representation of a user is generated by adjusting to characteristics of a scene in which the persona is to be presented. For purposes of explanation, the following steps are presented in a particular order. However, it should be understood that the various actions may be performed in a different order. Further, some actions may be performed simultaneously, and some may not be required, or others may be added.

The flow diagram begins with tracking data 102 of a subject 100. The tracking data 102 may include image data and/or other sensor data captured of a physical user from which the virtual representation of the user is to be generated. The tracking data 102 may be captured, for example, during runtime, such as during a tracking stage. The tracking data 102 may be captured by one or more cameras of an electronic device, such as a sending device 140 associated with a tracked subject 100. In some embodiments, the device capturing the subject image may additionally capture depth information of the subject 100, for example using a depth sensor. As such, the tracking data 102 may include data from multiple capture devices and/or from sensor data captured at different times. According to one or more embodiments, the tracking data may be captured from a wearable device, such as a head mounted device. Thus, as shown, tracking data may include multiple image frames capturing different portions of the user's face, such as image frame 105A and image frame 105B.

According to one or more embodiments, a persona geometry 110 may be generated by the sending device 140. In some embodiments, the persona geometry 110 is generated from enrollment data and adjusted based on the tracking data 102 to represent a current three-dimensional shape of the user. For example, a network may be used to generate a geometric representation of the user based on the tracking data, such as a persona network, a Pixel-Aligned Implicit Function (PIFu) network, an autoencoder network, a generative adversarial network (GAN), or the like. Further, the geometric representation of the user may take the form of a mesh, a point cloud, a volumetric representation, depth map, or the like. In addition, the geometric representation may be composed of a combination of different types of representations.

According to some embodiments, the persona geometry 110 may be used to generate a persona 115, which may be a photorealistic virtual representation of characteristics of the user as captured in tracking data 100. Because persona geometry 110 is generated without regard for environmental conditions of a scene (apart from any which may affect the captured tracking data of the subject), the persona geometry 110 is an environment-agnostic geometric representation of the subject. Persona 115 may be generated in a number of ways, and typically involves combining a geometry with image data to generate the virtual representation. In some embodiments, the image data may correspond to a texture of the persona. In some embodiments, the texture may be obtained based on the tracking data 100, or from another source, such as from enrollment data captured prior to the tracking stage. As shown, persona 115 may be generated by the sending device 140. Additionally, or alternatively, the persona 115 may be generated by a remote device. Persona 115 is generated without regard to environmental features. As such, persona 115 is an environment-agnostic representation of the subject.

In some embodiments, the persona 115 may be placed or displayed in a particular scene when presented for display at another device. Scene 120 is an example of an environment in which the persona 115 should be presented. The scene may refer to a virtual or physical environment in which the subject of the persona 115 is located or the viewer is located. The virtual environment may include a virtual representation of a scene, and may be selected or provided by a device generating the persona data from tracking data 100, or may be selected at a receiving device, such as a viewer client device. In some embodiments, the scene of the environment in which the persona 115 is placed may be shared between the subject of the persona 115 and the viewer. For example, in a copresence environment, the viewer and the subject of the persona may be interacting with a shared XR environment in which the scene 120 is a virtual component. In this example, the scene 120 refers to a physical environment in which a viewer 155 is located. The viewer 155 may be a user active in a communication session with the subject 100. For example, the viewer 155 may be using a separate electronic device, such as receiving device 150, to interact with the subject 100 in a copresence environment.

According to one or more embodiments, the receiving device 150 may obtain one or more environmental features for the scene 120. Environmental features are a representation of characteristics of the scene having a physical effect on the shape or motion of objects or people within the scene. The characteristics may include, for example, wind, rain, gravity, or the like. The characteristics may be encoded in a number of ways, such as key words, latent vectors, motion information, or the like. In embodiments in which the scene 120 is a physical environment, environmental features may be obtained in a number of ways. For example, environmental features may be detected or measured by a sensor or device located within the environment. Example sensors may include a microphone, anemometer, ambient light sensor, temperature sensor, humidity sensor, atmospheric pressure sensor, and the like. As another example, environmental features may be predefined for the scene, or derived from other information about the scene. For example, environmental features may be inferred from visual cues in the scene, such as rain, wind blowing, gravitational effects on objects in the scene, and the like. In the example shown, scene 120 includes a tree that is losing leaves from being blown by wind. The tree leans slightly to the left. These visual cues may be detected by a network trained to determine environmental features from image data. Alternatively, the wind may be measured by a sensor in the scene and obtained by the local device for generating a persona. In some embodiments, the environmental features may be embedded in the scene 120, or transmitted with the scene 120 in the form of metadata.

According to one or more embodiments, providing an environmentally-adjusted persona involves using the environmental features to adjust a persona geometry to obtain an environmentally-adjusted geometric representation of a user. For example, in FIG. 1, adjusted persona geometry 125 is generated from persona geometry 110 and scene 120. According to some embodiments, the environmental features of scene 120 may be translated into a form in which the environmental features can affect the shape or motion of the persona geometry 110. For example, the environmental features may be decoded or mapped such that the corresponding adjustment to the persona geometry 110 can be applied. As an example, if the persona geometry is in the form of a mesh, the vertices of the mesh may be adjusted based on the environmental features.

The adjusted persona geometry 125 and scene 120 can be used to generate a composited scene 130 in which an adjusted persona 135 may be presented. The adjusted persona may be rendered using the adjusted persona geometry 125 and texture data for the subject of the persona. Adjusted persona 135 may be generated in a number of ways, and typically involves combining an adjusted geometry with image data to generate the virtual representation. In some embodiments, the image data may correspond to a texture of the persona. In some embodiments, the texture may be obtained based on the tracking data 100, or from another source, such as from enrollment data captured prior to the tracking stage. In some embodiments, the texture of adjusted persona 135 may be the same as the texture of persona 115, and may be warped over the adjusted persona differently. Alternatively, the texture applied for adjusted persona 135 may be modified or adjusted, for example based on the environmental features of scene 120. Generating the composited scene may include rendering the adjusted persona 135 over the scene 120 in a manner such that the adjusted persona 135 appears to be placed among components of the scene 120. For example, lighting, opacity, and other visual features of the adjusted persona 135 maybe selected in accordance with properties of the scene 120.

According to one or more embodiments, the adjusted persona geometry 125, adjusted persona 135, and/or composited scene 130 may be generated on a per-frame basis, for example based on dynamic environmental features from scene 120. Accordingly, the resulting adjusted persona 135 may appear to move realistically in response to environmental conditions of scene 120. In the example shown, the hair of adjusted persona 135 is being blown towards the left, so as to respond to wind in a same manner as the tree in the scene 120. By contrast, the subject 100 is tracked indoors where no wind is blowing.

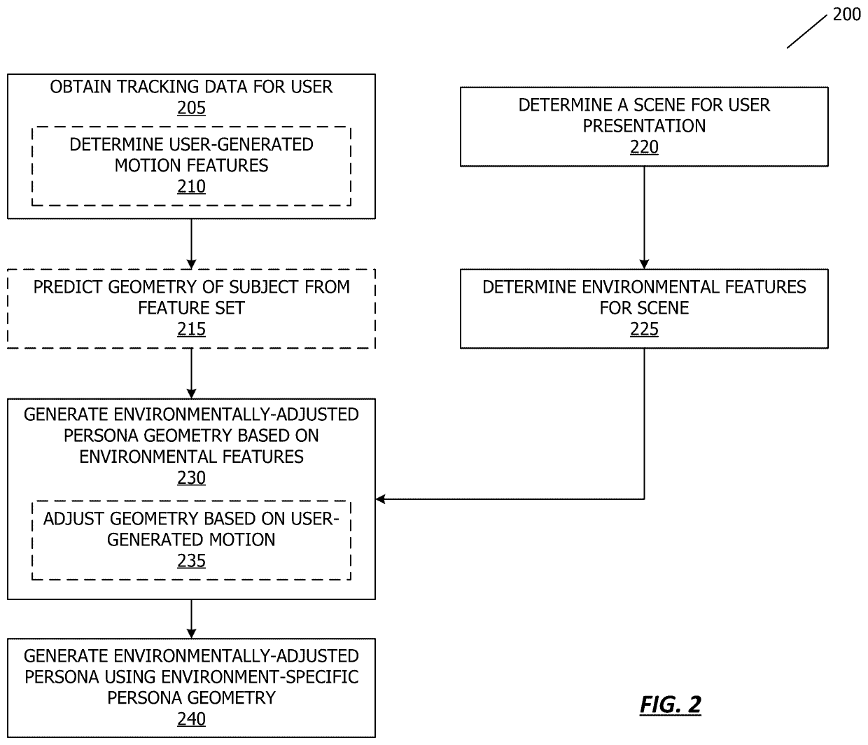

Because adjusted persona 135 has been generated based on environmental features of the scene, adjusted persona 135 may be considered an environmentally-adjusted persona. FIG. 2 shows a flowchart of a technique for determining an environmentally-adjusted geometric representation of a person, according to one or more embodiments. For purposes of explanation, the following steps will be described in the context of FIGS. 1-2. However, it should be understood that the various actions may be performed by alternate components. In addition, the various actions may be performed in a different order. Further, some actions may be performed simultaneously, and some may not be required, or others may be added.

The flowchart 200 begins at block 205, where tracking data is obtained of the user. As described above, the tracking data may include image data and/or other sensor data captured of a physical user from which the virtual representation of the user is to be generated. In addition, the tracking data may also include depth information captured by one or more depth sensors. The tracking data may be captured by one or more cameras of an electronic device.

Optionally, as shown at block 210, user generated motion features may be determined. The user generated motion features may include representations of motion information corresponding to the tracking data. The motion features may indicate movement of portions of the user indirectly caused by a user motion. As an example, as a user with long hair tips their head to the left, their hair will not remain in a static formation around the head, but will fall with gravity. These types of user-driven indirect motion features may be detected based on user movement, and encoded as user-generated motion features. The user-driven indirect motion features may be represented in various forms, such as latent variables, motion vectors, or the like.

The flowchart 200 proceeds to block 215, where the geometry of the subject is predicted from the feature set. According to some embodiments, the geometry may be predicted based on the tracking data without consideration of the user-driven indirect motion features. Alternatively, the geometry of the subject may be predicted in accordance with the tracking data and the user-driven indirect motion features. In particular, three-dimensional characteristics of the user can be predicted based on the tracking data. Accordingly, the geometry of the user may take the form of a mesh, a point cloud, a volumetric representation, depth map, or the like. In addition, the geometric representation may be composed of a combination of different types of representations.

The flowchart additionally includes, at block 220, determining a scene for user presentation. In particular, the scene in which the persona is to be presented is determined. According to one or more embodiments, the scene may be a physical environment or a virtual environment. Further, the scene may be a scene for the device presenting the persona, or the scene in which the user corresponding to the persona is located. Furthermore, the scene may be a virtual scene that is shared among the receiving device and the device used by the subject of the persona, for example in a copresence environment.

The flowchart 200 proceeds to block 225, where environmental features of the scene are determined. In embodiments in which the scene is a physical environment, environmental features may be obtained in a number of ways. For example, environmental features may be detected or measured by a sensor or device located within the environment. As another example, environmental features may be predefined for the scene, or derived from other information about the scene. For example, environmental features may be inferred from visual cues in image data of the scene, such as rain, wind blowing, gravitational effects on objects in the scene, and the like. In some embodiments, the environmental features may be embedded in the scene, or transmitted with the scene, for example in the form of metadata. To that end, the environmental features may be generated by a network which is trained to translate the characteristics of the physical environment, for example from sensor data, into a format usable to adjust or affect a virtual representation of a user.

The flowchart 200 proceeds to block 230, where an environmentally-adjusted persona geometry is generated based on the environmental features. According to one or more embodiments, generating an environmentally-adjusted persona involves using the environmental features to adjust a persona geometry. According to some embodiments, the environmental features of scene from block 225 may be translated into a form in which the environmental features can affect the shape or motion of the persona geometry generated at block 215. For example, the environmental features may be decoded or mapped such that the corresponding adjustment to the persona geometry generated at optional block 215 can be applied. As an example, if the persona geometry is in the form of a mesh, the vertices of the mesh may be adjusted based on the environmental features.

In some embodiments, the tracking data and the environmental features can be used in combination to generate an environmentally-adjusted persona geometry at block 230. For example, representations of the tracking data may be combined with representations of the environmental features and fed into a single network configured to generate environmentally-adjusted persona data, such as the environmentally-adjusted geometry and/or image data. As another example, if a geometry of the subject was presented at block 215, then the predicted geometry from block 215 may be adjusted based on the environmental features. For example, the geometry and the features may be fed into a network trained to adjust a geometry based on the environmental features. As another example, the environmental features may encode information related to a classification of portions of the geometry which are affected by the characteristics of the scene. For example, wind may affect hair, but not affect skin on the face. As another example, a change in gravity may change different portions of the geometry differently. In some geometric representations, different portions of the geometry may be tagged or otherwise classified as belonging to a particular facial feature or other part of the subject. As an example, if the geometry is represented in the form of a point cloud, various points in the point cloud may be identified as belonging to different portions of the user, such as a forehead, lips, neck, and the like. Similarly, if the geometry is represented in the form of a mesh, various vertices may be identified as belonging to different portions of the user. Thus, the environmental features may identify portions of the geometry of the subject which are affected by the environmental condition such that a corresponding portion of the subject geometry can be identified.

Optionally, at block 235, the geometry is further adjusted based on user-generated motion. This may occur, for example, if user-generated motion features are determined at block 210, and those features were not already used in predicting the geometry at block 215. In some embodiments the environmental features from block 225 may be combined with motion features from block 210 to generate the environmentally-adjusted persona.

The flowchart 200 concludes at block 240, where a persona is generated using the user-specific geometry. The environmentally-adjusted persona may be rendered using the environmentally-adjusted persona geometry from block 230 and texture data for the subject of the persona. The persona may be generated in a number of ways, and typically involves combining an adjusted geometry with image data to generate the virtual representation. In some embodiments, the image data may correspond to a texture of the persona.

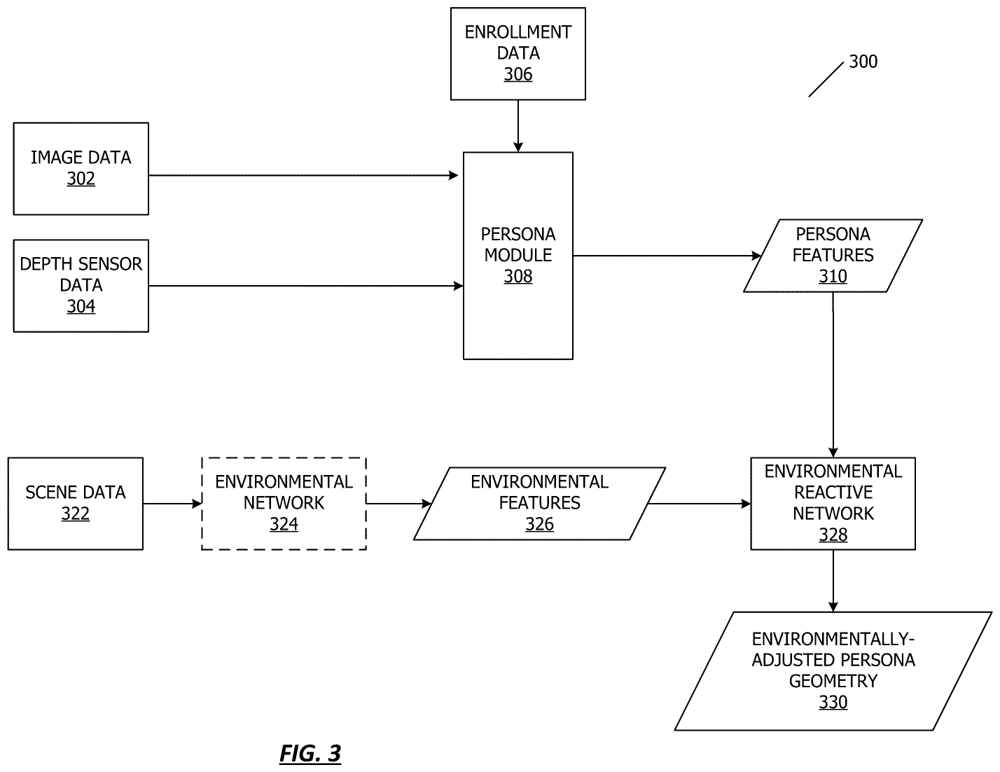

FIG. 3 shows a flow diagram of a technique for generating an environmentally-adjusted persona geometry, in accordance with one or more embodiments. The flow diagram of FIG. 3 depicts an example data flow for generating an environmentally-adjusted persona. However, it should be understood that the various processes may be performed differently or in an alternate order.

The flow diagram 300 begins with an image data 302. The image data 302 may be an image of a user or other subject, such as the subject image captured in image frame 105A and image frame 105B from tracking data 100 as shown in FIG. 1. The image data may be captured, for example, during runtime, such as during a tracking stage by one or more cameras of an electronic device. According to one or more embodiments, the image data may be captured from a wearable device, such as a head mounted device as it is worn by a user. Thus, as shown, tracking data may include multiple image frames capturing different portions of the user's face.

In addition to the image data 302, depth sensor data 304 may be obtained corresponding to the image. That is, depth sensor data 304 may be captured by one or more depth sensors which correspond to the subject in the image data 302. Additionally, or alternatively, the image data 302 may be captured by a depth camera and the depth and image data may be concurrently captured. As such, the depth sensor data 304 may indicate a relative depth of the surface of the subject from the point of view of the device capturing the image/sensor data.

According to one or more embodiments, the image data 302 and depth sensor data 304 may be applied to a persona module 308 to obtain a set of persona features 310 for the representation of the subject. The persona module 308 may include one or more networks configured to translate the various sensor data into features or representations which can be combined to generate a persona. Examples include a Pixel-Aligned Implicit Function (PIFu) network, an autoencoder network, a generative adversarial network (GAN), or the like, or some combination thereof. In some embodiments, the persona module 308 may additionally use enrollment data 306 which may include predefined characteristics of the user such as geometry, texture, skeleton, bone length, and the like. The enrollment data 306 may be captured, for example, during an enrollment period in which a user utilizes a personal device to capture an image directed at the user's face from which enrollment data may be derived. Persona features 310 may include a representation of the characteristics of the user which can be used to generate a photorealistic virtual representation of the subject. For example, the persona features may include a representation of a geometry of the persona, and/or a representation of a texture of the persona. The geometry of the persona may take the form of a mesh, a point cloud, a volumetric representation, depth map, or the like. The geometry of the persona may be encoded as persona features 310, which may include data from which the geometry can be determined such as latent variables, feature vectors, or the like. In addition, the geometric representation may be composed of a combination of different types of representations.

Along with the determination of the persona features 310, environmental features may be determined. Accordingly, the flow diagram 300 also includes obtaining scene data 322. The scene data may correspond to a virtual or physical environment in which the subject of the persona or the viewer is located. The virtual environment may include a virtual representation of a scene, and may be selected or provided by a sending device or a receiving device. In some embodiments, the scene of the environment in which the persona is placed may be shared between the subject of the persona and the viewer. According to one or more embodiments, scene data 322 may be a virtual scene for which environmental features 326 are provided. In some embodiments, environmental features 326 may be encoded in a number of ways, such as key words, latent vectors, motion information, or the like. In embodiments in which the scene 120 is a physical environment, environmental features may be obtained in a number of ways. For example, environmental features may be detected or measured by a sensor or device located within the environment in which the persona of the subject is to be rendered. As another example, environmental features may be predefined for the scene, or derived from other information about the scene. Alternatively, the wind may be measured by a sensor in the scene and obtained by the local device for generating a persona. To that end, the environmental features may be generated by an environmental network 324 which is trained to translate the characteristics of the physical environment, for example from sensor data, into a format usable to adjust or affect a virtual representation of a user such as a feature vector, latent variables, or the like. In some embodiments, the environmental features may be embedded in the scene, or transmitted with the scene in the form of metadata.

In some embodiments, an environmental reactive network 328 may be configured to generate an environmentally-adjusted persona geometry 330. In particular, the environmental reactive network may be configured to combine the environmental features 326 and the persona features 310, and generate persona data that provides a photorealistic representation of the subject reacting to characteristics of the scene in which the persona is to be presented. In some embodiments, the environmental reactive network 328 may be configured to generate geometry information for the persona and/or texture information for the persona.

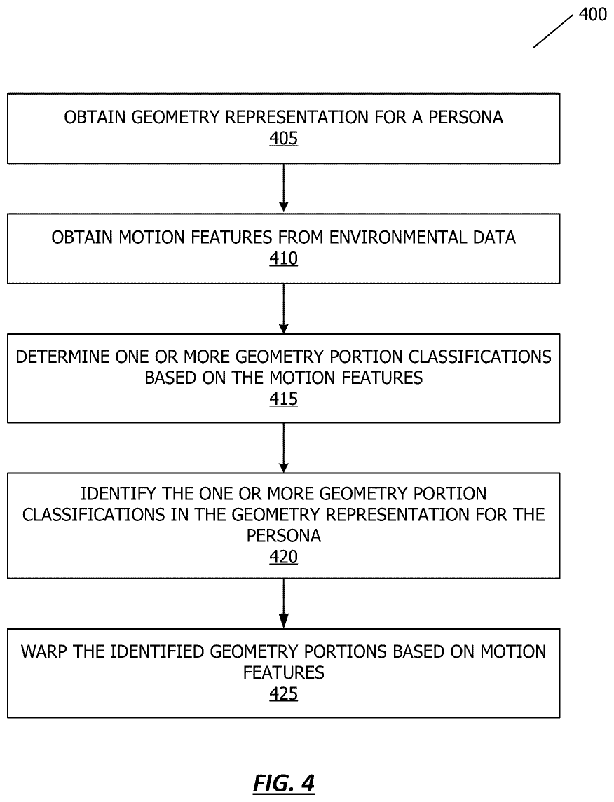

As described above, the geometry of the persona may be adjusted based on environmental features using various techniques. FIG. 4 depicts a flowchart of a technique for modifying a geometry representation of a user based on motion features, in accordance with one or more embodiments. For purposes of explanation, the following steps will be described in the context of particular components. However, it should be understood that the various actions may be performed by alternate components. In addition, the various actions may be performed in a different order. Further, some actions may be performed simultaneously, and some may not be required, or others may be added.

A flowchart 400 begins at block 405, where a geometry representation of persona is obtained. The geometry representation take the form of a mesh, a point cloud, a volumetric representation, depth map, or the like. In addition, the geometric representation may be composed of feature vectors, latent values, or the like from which the geometry may be obtained. For example, the geometry may be predicted based on tracking data during runtime and/or enrollment data.

The flowchart 400 proceeds to block 410, where motion vectors are obtained from the environmental data. The environmental data may indicate, for example, characteristics of the scene which affect a physical representation of a user in the scene. In some embodiments, the environmental data may include motion features, indicating characteristics of the affect of the environment on the shape or movement of the representation of the persona.

At block 415, one or more geometry portion classifications are determined based on the motion features. In some embodiments, the motion features may encode data related to the effect of environmental feature on the persona geometry, as well as an identifier of one or more portions of the geometry to which the adjustment is applied. As an example, the motion features may indicate an amount of motion and/or characteristics of the geometry representation affected by the motion, such as hair, cheeks, lips, eyes, torso, and the like. If motion features are additionally received corresponding to user-generated motion, the motion features from the environment may be combined with the motion features for user-generated motion. The geometry portion classifications may be determined based on the combination of the motion features.

The flowchart 400 proceeds to block 420, where the one or more geometry portion classifications are identified in the geometry representation for the persona. According to one or more embodiments, the geometry representation of the persona may be associated with segmentation labels for different portions of the geometry. For example, each vertex or set of vertices may be associated with a segmentation label indicating a portion of the persona to which the vertex or set of vertices belong.

The flowchart 400 concludes at block 425, where the identified geometry portions are warped based on the motion features. The geometry portions may be affected in various ways. For example, geometry features may be combined with environmental features to generate an environmentally-adjusted representation of the subject. As another example, the vertices, feature points, or other geometric representations associated with particular portions of the persona identified at block 425 to be warped or adjusted in accordance with the motion features.

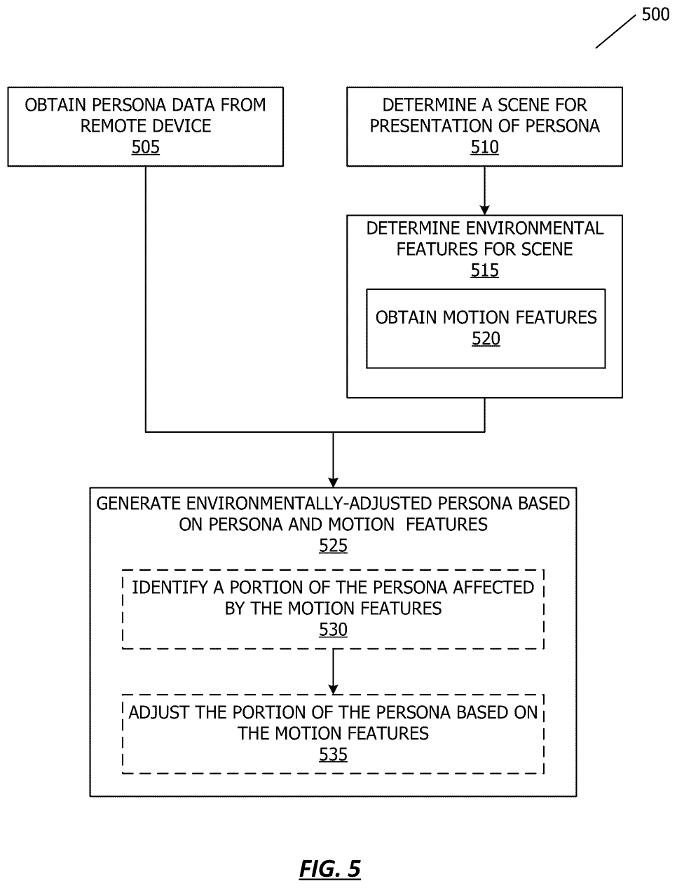

According to some embodiments, a receiving device may receive persona data from a remote device for which a subject of a persona is being captured. For example, a local device may be used by a local user to view an extended reality environment in which a persona is presented representing a subject at a remote device. The local device may determine a scene for presentation of the persona of the subject and adjust the persona locally so that the persona appears to be responding to the environment in which the persona is presented. Accordingly, FIG. 5 depicts a flowchart of an example technique for generating an environment specific persona at a receiving device, in accordance with one or more embodiments. Said another way, FIG. 5 shows a flowchart of a technique for modifying an environment-agnostic persona based on motion features in a scene, according to some embodiments. For purposes of explanation, the following steps will be described in the context of particular components. However, it should be understood that the various actions may be performed by alternate components. In addition, the various actions may be performed in a different order. Further, some actions may be performed simultaneously, and some may not be required, or others may be added.

The flowchart 500 begins at block 505, where persona data is obtained from a sending/remote device. According to one or more embodiments, the persona data may include a constructed environment-agnostic persona having a geometry and texture, or may be in the form of persona features from which the persona may be constructed. To that end, persona data may include a representation of the characteristics of the user which can be used to generate a photorealistic virtual representation of the subject. For example, the persona features may include a representation of a geometry of the persona, and/or a representation of a texture of the persona. The geometry of the persona may take the form of a mesh, a point cloud, a volumetric representation, depth map, or the like.

The flowchart 500 additionally begins with block 510, where a scene in which the persona is to be presented is determined. The scene may refer to a physical environment in which the receiving/local device is located, or a virtual environment. The physical environment and features thereof may be detected or measured by the receiving device. For example, the viewer may perceive the physical environment through pass-through camera data, through a see-through display, or the like. The virtual environment may include a virtual representation of a scene, and may be selected at a receiving device, such as a viewer client device. In some embodiments, the scene of the environment in which the persona is placed may be shared between the subject of the persona and the viewer. For example, in a copresence environment, the viewer and the subject of the persona may be interacting with a shared XR environment in which the scene is a virtual component.

The flowchart 500 continues to block 515, where environmental features for the scene are determined. According to one or more embodiments, scene 120 may be a virtual scene for which environmental features are provided. Environmental features are a representation of characteristics of the scene having a physical effect on the shape or motion of objects or people within the scene. The characteristics may include, for example, wind, rain, gravity, or the like. The characteristics may be encoded in a number of ways, such as key words, latent vectors, motion information, or the like. In embodiments in which the scene 120 is a physical environment, environmental features may be obtained in a number of ways. For example, environmental features may be detected or measured by a sensor or local device located within the physical environment. As another example, environmental features may be predefined for the scene, or derived from other information about the scene. For example, environmental features may be encoded in metadata or inferred from visual or other cues in the scene, such as rain, wind blowing, gravitational effects on objects in the scene, and the like.

At block 520, motion features are obtained based on the environmental features. In some embodiments, the motion features may indicate how the environmental characteristics of the scene affect the motion of the persona. In some embodiments, the motion features may be included in the environmental features. Alternatively, the motion features may be derived from the environmental features. For example, a network may be trained to predict the effect of environmental characteristics on different portions of a persona.

The flowchart proceeds to block 525, where environment specific persona is generated based on the persona data and the motion features. According to one or more embodiments, generating an environmentally-adjusted persona involves using the environmental features to adjust a persona geometry. According to some embodiments, the motion features may be used to modify the shape or motion of the persona geometry generated at block 505.

Optionally, generating the environment specific persona includes, at optional block 530, identifying a portion of the persona affected by the motion features. The different portions may be encoded as part of the motion features obtained at block 520. Alternatively, the portions of the persona affected may be determined by predicting which portions of the persona are affected by motion features.

At block 535, the portion of the persona identified at block 530 is adjusted based on the motion features. For example, if the persona geometry is in the form of a mesh, the vertices of the mesh may be adjusted based on the environmental features. Similarly, if the persona geometry is in a point cloud representation, the point cloud representation may be adjusted in accordance with the motion vectors corresponding to different portions of the representation.

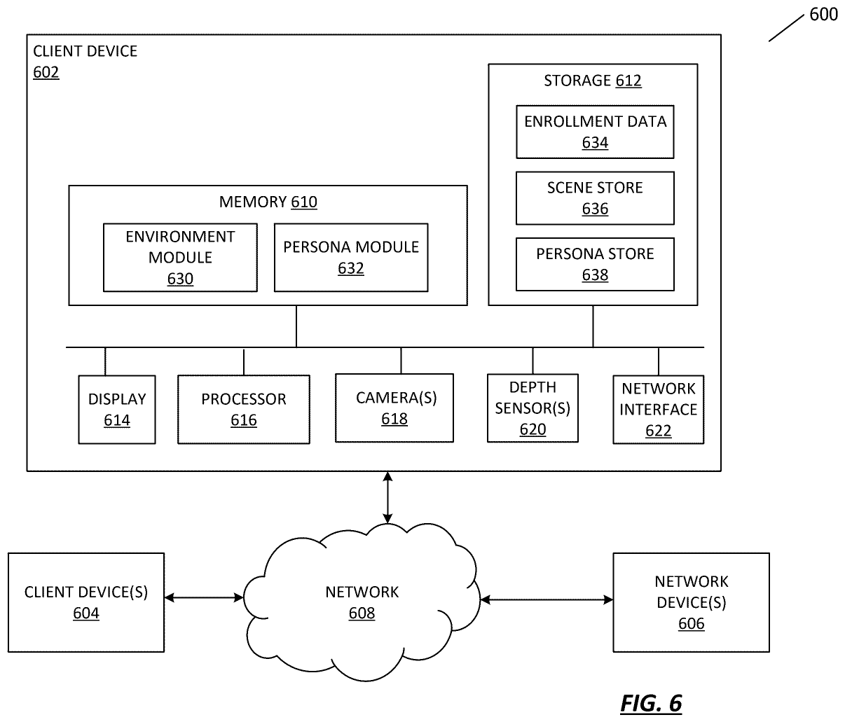

Referring to FIG. 6, a simplified network diagram 600 including a client device 602 is presented. The client device may be utilized to generate a three-dimensional representation of a subject in a scene. The network diagram 600 includes client device 602 which may include various components. Client device 602 may be part of a multifunctional device, such as a phone, tablet computer, personal digital assistant, portable music/video player, wearable device, head mounted device, base station, laptop computer, desktop computer, mobile device, network device, or any other electronic device that has the ability to capture image data.

Client device 602 may include one or more processors 616, such as a central processing unit (CPU). Processor(s) 616 may include a system-on-chip such as those found in mobile devices and include one or more dedicated graphics processing units (GPUs) or other graphics hardware. Further, processor(s) 616 may include multiple processors of the same or different type.

Client device 602 may also include storage 612. Storage 612 may include enrollment data 634, which may include data regarding user-specific profile information, user-specific preferences, and the like. Enrollment data 634 may additionally include data used to generate avatars specific to the user, such as a geometric representation of the user, joint locations for the user, a skeleton for the user, and the like. Further, enrollment data 634 may include a texture or image data of the user and the like. Enrollment data 634 may be obtained during an enrollment phase in which a user uses an electronic device to collect sensor data of themselves from which personas can be generated, for example during device or profile setup. Storage 612 may also include a scene store 636. Scene store 636 may be used to store environment content for scenes in which a persona may be presented, either a persona related to a user of the client device 602 and/or a persona related to one or more users from one or more other client device(s) 604. In some embodiments, scene store 636 may store environmental features for scenes in which the persona may be presented and/or a persona related to one or more users from one or more other client device(s) 604. Storage 612 may also include a persona store 638, which may store data used to generate graphical representations of user movement, such as geographic data, texture data, predefined characters, and the like.

Client device 602 may also include a memory 610. Memory 610 may include one or more different types of memory, and may be configured to hold computer readable code which, when executed by processor(s) 616, cause the client device 602 to perform device functions. Memory 610 may store various programming modules for execution by processor(s) 616, including environment module 630, avatar module 632, and potentially other various applications. According to one or more embodiments, environment module 630 may be used to generate or render a scene to display, for example, on display 614. Further, environment module 630 may be configured to predict environmental features from a given physical or virtual scene. Environment module 630 may additionally be used to render a persona in a particular scene, for example, based on environmental features or other data from scene store 636.

In some embodiments, the client device 602 may include other components utilized for user enrollment, such as one or more cameras 618 and/or other sensor(s) 620, such as one or more depth sensors, temperature sensors, motion sensors, or the like. In one or more embodiments, each of the one or more cameras 618 may be a traditional RGB camera, a depth camera, or the like. The one or more cameras 618 may capture input images of a subject for determining 3D information from 2D images. Further, camera(s) 618 may include a stereo or other multicamera system.

Although client device 602 is depicted as comprising the numerous components described above, and one or more embodiments, the various components and functionality of the components may be distributed differently across one or more additional devices, for example across network 608. For example, in some embodiments, any combination of storage 612 may be partially or fully deployed on additional devices, such as network device(s) 606, or the like.

Further, in one or more embodiments, client device 602 may be composed of multiple devices in the form of an electronic system. For example, input images may be captured from cameras on accessory devices communicably connected to the client device 602 across network 608, or a local network via network interface 622. As another example, some or all of the computational functions described as being performed by computer code in memory 610 may be offloaded to an accessory device communicably coupled to the client device 602, a network device such as a server, or the like. Accordingly, although certain calls and transmissions are described herein with respect to the particular systems as depicted, in one or more embodiments, the various calls and transmissions may be differently directed based on the differently distributed functionality. Further, additional components may be used, or some combination of the functionality of any of the components may be combined. For example, the client device 602 may communicate with one or more client device(s) 604 across network 608 to transmit and/or receive persona data. As another example, client device 602 may communicate with one or more client device(s) 604 across network 608 to participate in a copresence environment.

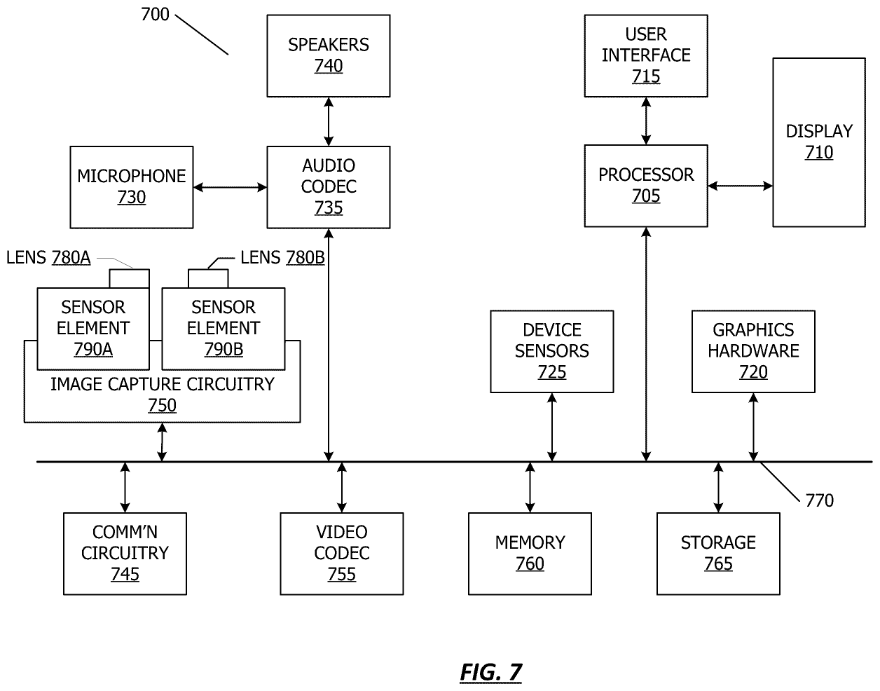

Referring now to FIG. 7, a simplified functional block diagram of illustrative multifunction electronic device 700 is shown according to one embodiment. Each of the electronic devices may be a multifunctional electronic device or may have some or all of the described components of a multifunctional electronic device described herein. Multifunction electronic device 700 may include some combination of processor 705, display 710, user interface 715, graphics hardware 720, device sensors 725 (e.g., proximity sensor/ambient light sensor, accelerometer and/or gyroscope), microphone 730, audio codec 735, speaker(s) 740, communications circuitry 745, digital image capture circuitry 750 (e.g., including camera system), memory 760, storage device 765, and communications bus 770. Multifunction electronic device 700 may be, for example, a mobile telephone, personal music player, wearable device, tablet computer, and the like.

Processor 705 may execute instructions necessary to carry out or control the operation of many functions performed by device 700. Processor 705 may, for instance, drive display 710 and receive user input from user interface 715. User interface 715 may allow a user to interact with device 700. For example, user interface 715 can take a variety of forms, such as a button, keypad, dial, a click wheel, keyboard, display screen, touch screen, and the like. Processor 705 may also, for example, be a system-on-chip such as those found in mobile devices and include a dedicated GPU. Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include one or more lens assemblies, such as 780A and 780B. The lens assemblies 780A and 780B may have a combination of various characteristics, such as differing focal length and the like. For example, lens assembly 780A may have a short focal length relative to the focal length of lens assembly 780B. Each lens assembly may have a separate associated sensor element 790A and sensor element 790B. Alternatively, two or more lens assemblies may share a common sensor element. Image capture circuitry 750 may capture still images, video images, enhanced images, and the like. Output from image capture circuitry 750 may be processed, at least in part, by video codec(s) 755 and/or processor 705, and/or graphics hardware 720, and/or a dedicated image processing unit or pipeline incorporated within circuitry 745. Images so captured may be stored in memory 760 and/or storage 765.

Memory 760 may include one or more different types of media used by processor 705 and graphics hardware 720 to perform device functions. For example, memory 760 may include memory cache, read-only memory (ROM), and/or random-access memory (RAM). Storage 765 may store media (e.g., audio, image, and video files), computer program instructions or software, preference information, device profile information, and any other suitable data. Storage 765 may include one more non-transitory computer-readable storage mediums, including, for example, magnetic disks (fixed, floppy, and removable) and tape, optical media such as CD-ROMs and digital video discs (DVDs), and semiconductor memory devices such as Electrically Programmable Read-Only Memory (EPROM), and Electrically Erasable Programmable Read-Only Memory (EEPROM). Memory 760 and storage 765 may be used to tangibly retain computer program instructions or computer readable code organized into one or more modules and written in any desired computer programming language. When executed by, for example, processor 705, such computer program code may implement one or more of the methods described herein.

Various processes defined herein consider the option of obtaining and utilizing a user's identifying information. For example, such personal information may be utilized in order to track motion by the user. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 1-5 or the arrangement of elements shown in FIGS. 6-7 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain English equivalents of the respective terms “comprising” and “wherein.”

1. A method comprising:
obtaining environmental features for a scene in which a representation of a user is to be presented;
obtaining tracking data for a user;
generating an environmentally-adjusted geometric representation of the user based on the tracking data and the environmental features; and
generating a virtual representation of the user in the scene using the environmentally-adjusted geometric representation.

2. The method of claim 1, wherein generating the environmentally-adjusted geometric representation comprises:
generating an environment-agnostic geometric representation of the user based on the tracking data; and
adjusting the environment-agnostic geometric representation in accordance with the environmental features.

3. The method of claim 2, further comprising:
determining user motion from the tracking data; and
adjusting the environment-agnostic geometric representation further in accordance with the user motion.

4. The method of claim 2, wherein generating an environmentally-adjusted geometric representation in accordance with the environmental features further comprises:
determining a classification for each of a set of portions of the of a geometry of a user to obtain a plurality of classifications;
identifying at least one classification of the plurality of classifications affected by the environmental features; and
applying an adjustment to one or more portions of the set of portions of the geometry of the user based on the environmental features.

5. The method of claim 4, wherein each of the set of portions of the geometry are associated with one or more vertices of the geometry.

6. The method of claim 1, wherein the environmentally-adjusted geometric representation causes the virtual representation of the user to reflect environmental features of the scene.

7. The method of claim 1, wherein the environmental features comprises one or more characteristics of an environment of the scene corresponding to environmental features affecting a motion of objects in the scene.

8. A non-transitory computer readable medium comprising computer readable code executable by one or more processors to:
obtain environmental features for a scene in which a representation of a user is to be presented;
obtain tracking data for a user;
generate an environmentally-adjusted geometric representation of the user based on the tracking data and the environmental features; and
generate a virtual representation of the user in the scene using the environmentally-adjusted geometric representation.

9. The non-transitory computer readable medium of claim 8, wherein the computer readable code to generate the environmentally-adjusted geometric representation comprises computer readable code to:
generate an environment-agnostic geometric representation of the user based on the tracking data; and
adjust the environment-agnostic geometric representation in accordance with the environmental features.

10. The non-transitory computer readable medium of claim 9, further comprising computer readable code to:
determine user motion from the tracking data; and
adjust the environment-agnostic geometric representation further in accordance with the user motion.

11. The non-transitory computer readable medium of claim 9, wherein the computer readable code to generate an environmentally-adjusted geometric representation in accordance with the environmental features further comprises computer readable code to:
determine a classification for each of a set of portions of the of a geometry of a user to obtain a plurality of classifications;
identify at least one classification of the plurality of classifications affected by the environmental features; and
apply an adjustment to one or more portions of the set of portions of the geometry of the user based on the environmental features.

12. The non-transitory computer readable medium of claim 8, wherein the environmental features comprises characteristics of an environment of the scene corresponding to environmental features affecting a motion of objects in the scene.

13. The non-transitory computer readable medium of claim 8, wherein the scene comprises a virtual environment in which a virtual representation of a person is to be presented.

14. The non-transitory computer readable medium of claim 8, wherein the scene comprises a physical environment in which the virtual representation of the user is to be presented.

15. A system comprising:
one or more processors; and
one or more computer readable media comprising computer readable code executable by the one or more processors to:
obtain environmental features for a scene in which a representation of a user is to be presented;
obtain tracking data for a user;
generate an environmentally-adjusted geometric representation of the user based on the tracking data and the environmental features; and
generate a virtual representation of the user in the scene using the environmentally-adjusted geometric representation.

16. The system of claim 15, wherein the computer readable code to generate the environmentally-adjusted geometric representation comprises computer readable code to:
generate an environment-agnostic geometric representation of the user based on the tracking data; and
adjust the environment-agnostic geometric representation in accordance with the environmental features.

17. The system of claim 15, wherein the environmentally-adjusted geometric representation causes the virtual representation of the user to reflect environmental features of the scene.

18. The system of claim 15, wherein the environmental features comprises one or more characteristics of an environment of the scene corresponding to environmental features affecting a motion of objects in the scene.

19. The system of claim 15, wherein the scene comprises a virtual environment in which a virtual representation of a person is to be presented.

20. The system of claim 15, wherein the scene comprises a physical environment in which the virtual representation of the user is to be presented.
